(19) United States
(12) Patent Application Publication
(10) Pub. No.: US 2021/0192425 A1
(43) Pub. Date: Jun. 24, 2021

(54) CALCULATION SYSTEM, CALCULATION METHOD AND RECORDING MEDIUM ON WHICH CALCULATION PROGRAM IS RECORDED

(71) Applicant: NEC CORPORATION, Tokyo (JP)

(72) Inventor: Hironobu MORI, Tokyo (JP)

(73) Assignee: NEC CORPORATION, Tokyo (JP)

(21) Appl. No.: 16/498,482

(22) PCT Filed: Mar. 20, 2018
(86) PCT No.: PCT/JP2018/010934

§ 371 Date: Sep. 27, 2019

(30) Foreign Application Priority Data
Mar. 31, 2017 (JP) 2017-069455

(51) Int. Cl. G06Q 10/06

(52) U.S. Cl. CPC G06Q 10/063114; G06Q 10/06314

(57) ABSTRACT

Even when the number of elements increases in an allocation problem, a calculation system can acquire an appropriate combination, and when resources usable a plurality of times within a period from a start time to an end time are used without overlapping for the longest time, the system includes: a node table construction unit that defines, concerning each resource, a next time zone available after the resource, and defines another resource and its time zone available after the resource; a longest path search unit that traces, one by one, the defined resources and time zones, and thereby detects the longest process for which the sum of used time is longest; and a solution output unit that outputs the specified process, wherein only a time zone of the resource after the most posterior time zone among the already-defined time zones of the resources is targeted.

### TECHNICAL FIELD

The present invention relates to a calculation system, and particularly relates to a calculation system and the like that solve an allocation problem.

### BACKGROUND ART

The allocation problem is a problem of determining which element among elements (b1, b2, b3 . . . ) of a set B is allocated to an element (a1, a2, a3 . . . ) of a set A (FIG. 1). Generally, in the allocation problem, as the number of elements increases, the number of combinations of elements increases in an order of factorial. When attempting to search an enormous number of the combinations for the optimum combination, it takes an enormous processing time. For this reason, generally, in the allocation problem, as the number of elements increases, it becomes more difficult to acquire the optimum combination (a combination explosion).

For example, in a case where it is decided to assign, to a worker C and a worker D, in unoccupied time sections, work that can be done only by either one of the workers, a question concerning, in order to maximize a total of working time, who is suitable to be asked to do the work at which time section is considered. The unoccupied time sections of the workers C and D in one day are assumed as illustrated in FIG. 2. In other words, this is a problem of allocating elements of a set of unoccupied time sections of the workers C and D in one day, to elements of a set of working time sections.

It is assumed that, in order to solve the problem, the following conditions are satisfied. (1) There is only one piece of equipment for performing the work, and a plurality of persons cannot do the work simultaneously. (2) The work is always performed from a start to an end of the unoccupied time section, and the work is not started from a middle of the unoccupied time section or finished in a middle of the unoccupied time section. Under the conditions, a total of working time is maximized.

As a result, in a case of a lower part of FIG. 2, the work can be done for the maximum of “13 hours”.

### CITATION LIST

### Patent Literature

[PTL 1] Japanese Unexamined Patent Application Publication No. 2008-064081

[PTL 2] Japanese Unexamined Patent Application Publication No. 2008-046808

### SUMMARY OF INVENTION

### Technical Problem

In the above-described example, the number of elements to be considered is set to be small, and for this reason, the optimum combination can be acquired by repeating minor trial and error. However, when the number of workers is increased, the number of pieces of equipment for performing work is increased, and a worker is allowed to be replaced in a middle of an unoccupied time section, the number of elements to be considered increases, and then it becomes difficult to acquire the optimum combination. An object of the present invention is to solve the above-described problem.

### Solution to Problem

A calculation system according to the present invention includes: when a plurality of management resources that can be used a plurality of times within a period from a start time to an end time are used without overlapping in time for a time as long as possible, a node table construction unit that, concerning each of all the management resources, performs first definition processing of defining a next time zone being available after use of the management resource, and performs second definition processing of defining another management resource and a time zone thereof being available after the use of the management resource; a longest path search unit that traces, one by one, the management resources and the time zones thereof defined by the node table construction unit, and thereby detects the longest process for which the sum of used time is longest; and a solution output unit that outputs the longest process being detected, wherein the node table construction unit selects, in the second definition processing, as a processing target, only a time zone of the management resource after the most posterior time zone among already-defined time zones of the management resources.

A calculation method according to the present invention includes: when a plurality of management resources that can be used a plurality of times within a period from a start time to an end time are used without overlapping in time for a time as long as possible, defining, concerning each of all the management resources, a next time zone being available after use of the management resource; defining another management resource and a time zone thereof being available after the use of the management resource; tracing, one by one, the management resources and the time zones thereof being defined, and thereby detecting the longest process for which the sum of used time is longest; and outputting the longest process being detected, wherein only a time zone of the management resource after the most posterior time zone among already-defined time zones of the management resources is selected as a processing target.

A calculation program according to the present invention causes a computer to function as: when a plurality of management resources that can be used a plurality of times within a period from a start time to an end time are used without overlapping in time for a time as long as possible, a means for defining, concerning each of all the management resources, a next time zone being available after use of the management resource; a means for defining another management resource and a time zone thereof being available after the use of the management resource; a means for tracing, one by one, the management resources and the time zones thereof being defined, and thereby detecting the longest process for which the sum of used time is longest; and a means for outputting the longest process being detected, wherein, in the second definition processing, only a time zone of the management resource after a most posterior time zone among already-defined time zones of the management resources is selected as a processing target.

The object of the present invention can be achieved also by a recording medium on which the above-described calculation program is recorded.

### Advantageous Effects of Invention

According to the present invention, in the allocation problem, the optimum combination is able to be acquired efficiently.

### BRIEF DESCRIPTION OF DRAWINGS

FIG. 1 is a concept diagram of an allocation problem.

FIG. 2 is an illustration of an example of the allocation problem.

FIG. 3 is an illustration of a generalized allocation problem according to an example embodiment of the present invention.

FIG. 4 is a block diagram illustrating a configuration of a calculation system according to the example embodiment of the present invention.

FIG. 5 is a flowchart illustrating an entire operation of the calculation system according to the example embodiment of the present invention.

FIG. 6 is a flowchart illustrating processing of initializing a node table in the calculation system according to the example embodiment of the present invention.

FIG. 7 is a diagram illustrating a data structure of the node table according to the example embodiment of the present invention.

FIG. 8 is a flowchart illustrating processing of constructing the node table in the calculation system according to the example embodiment of the present invention.

FIG. 9 is a flowchart illustrating processing of straight advance from a start to an end in the calculation system according to the example embodiment of the present invention.

FIG. 10 is a diagram illustrating a data structure of an edge according to the example embodiment of the present invention.

FIG. 11 is a diagram illustrating one example of the node table after the processing of the straight advance from the start to the end in the second stage is performed, according to the example embodiment of the present invention.

FIG. 12 is a flowchart illustrating processing of generating branches in the calculation system according to the example embodiment of the present invention.

FIG. 13 is a diagram illustrating a data structure of an index table according to the example embodiment of the present invention.

FIG. 14 is a flowchart illustrating processing of searching for the longest path in the calculation system according to the example embodiment of the present invention.

FIG. 15 is a flowchart illustrating processing of outputting a solution in the calculation system according to the example embodiment of the present invention.

FIG. 16 is a block diagram illustrating one example of a hardware configuration of a computer device according to the example embodiment of the present invention.

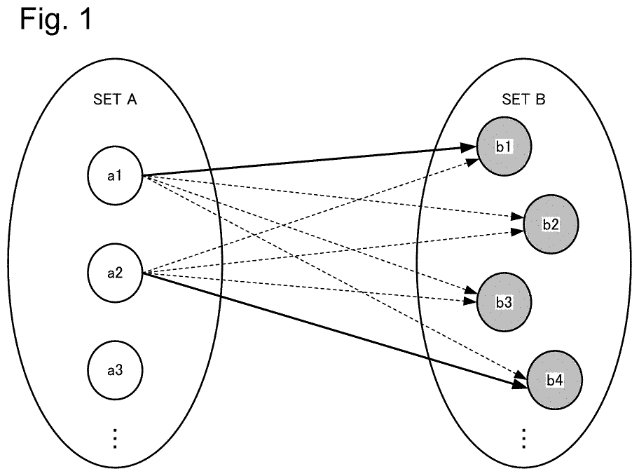

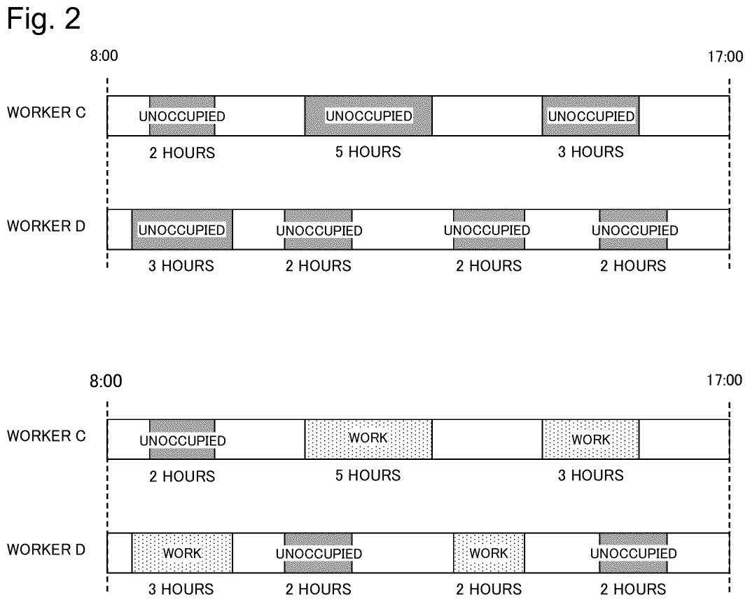

### Example Embodiment

Hereinafter, an example embodiment of the present invention is described in detail with reference to the drawings. Note that in the following description, the same reference symbols are attached to elements having the same functions, and description thereof is omitted in some cases.

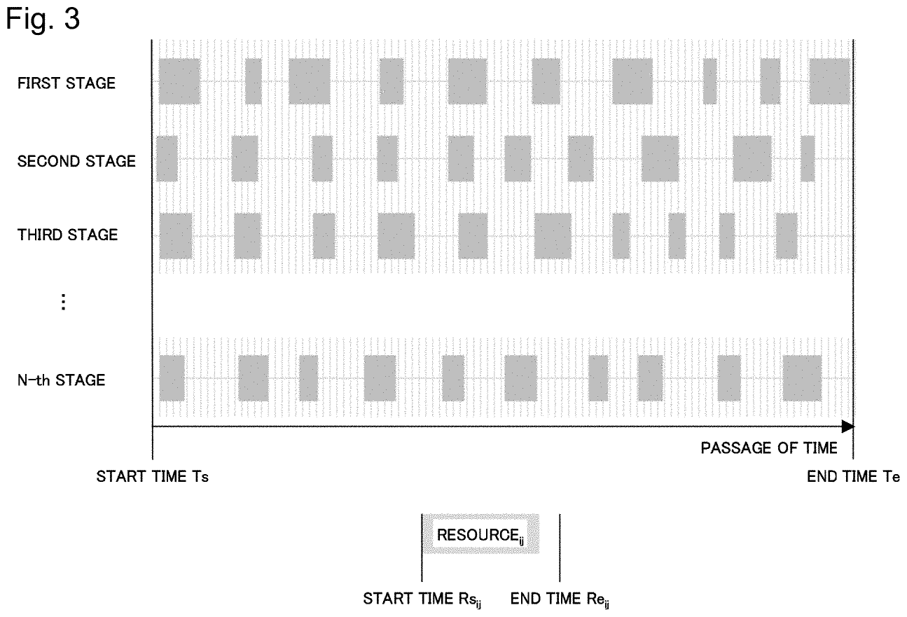

FIG. 3 is an illustration of a generalized allocation problem according to the example embodiment of the present invention. In the example embodiment of the present invention, the allocation problem generalized as follows is solved as follows. Specifically, the allocation problem that a plurality of resources are used within a period from a start time Ts to an end time Te for a time as long as possible, without overlapping in time is solved (an upper part in FIG. 3).

Here, the resources are management resources, and for example, include human resources such as the above-described “unoccupied time sections of workers” and equipment such as the above-described “pieces of equipment for performing work”. Alternatively, the resources include elements and devices of a processing system necessary for a computer in executing an operation, and include unoccupied time sections thereof.

Further, each of the resources is counted as a stage, and it is assumed that there are N stages of resources, and further, it is assumed that one stage (i.e., resource) is divided into P parts without overlapping in time. In other words, there are N management resources that can be each used P times. Hereinafter, j-th resource in i-th stage is referred to as a resource i, j (i is a natural number of 1 to N, and j is a natural number of 1 to P). It is assumed that each resource i, j can be used within a period from a start time Rs_{i,j} to an end time Re_{i,j} (a lower part in FIG. 3).

### (Configuration)

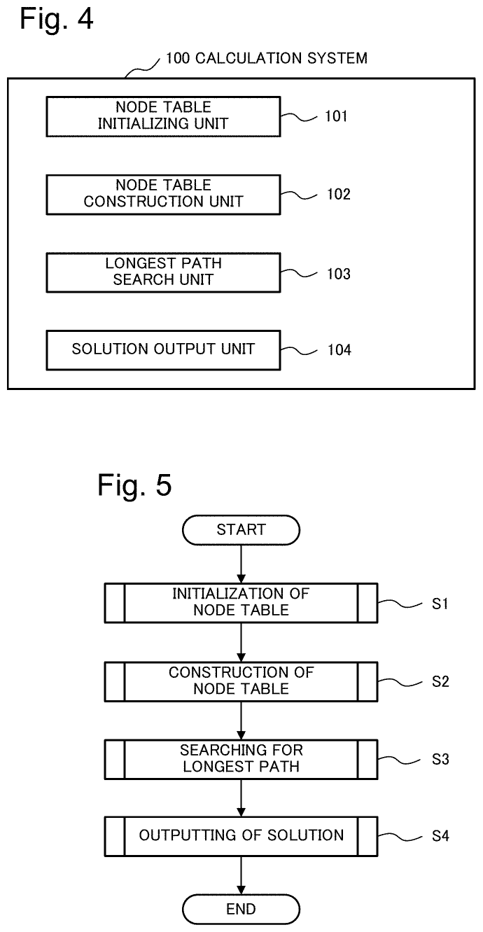

FIG. 4 is a block diagram illustrating a configuration of a calculation system according to the example embodiment of the present invention. The calculation system 100 according to the example embodiment of the present invention includes a node table initializing unit 101, a node table construction unit 102, a longest path search unit 103, and a solution output unit 104.

### (Operation)

FIG. 5 is a flowchart illustrating an entire operation of the calculation system according to the example embodiment of the present invention. The entire operation is roughly divided into four pieces of processing of initialization S1 of a node table, construction S2 of the node table, searching S3 for the longest path, and outputting S4 of a solution. Hereinafter, the details of each piece of the processing are described.

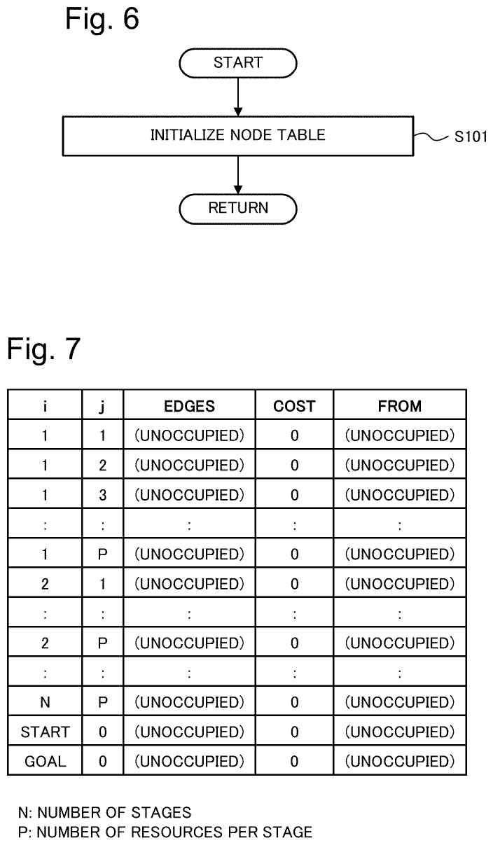

FIG. 6 is a flowchart illustrating the processing of initializing the node table in the calculation system according to the example embodiment of the present invention. The following describes the processing of the initialization S1 of the node table.

The node table initialization unit 101 substitutes “unoccupied” for all elements in a column of “EDGES” in the node table, substitutes “0” for all elements in a column of “COST” in the node table, and substitutes “unoccupied” for all elements in a column of “FROM” in the node table (step S101). When step S101 is ended, the node table initializing unit 101 ends the processing of the initialization S1 of the node table.

FIG. 7 is a diagram illustrating a data structure of the node table according to the example embodiment of the present invention. The node table is data having a two-dimensional array structure that includes column items of “i”, “j”, “EDGES”, “COST”, and “FROM”. The node table includes rows respectively associated with each of all combinations of “i” and “j”, and rows associated with (i=START, j=0) and (i=GOAL, j=0).

The above is the processing of the initialization S1 of the node table.

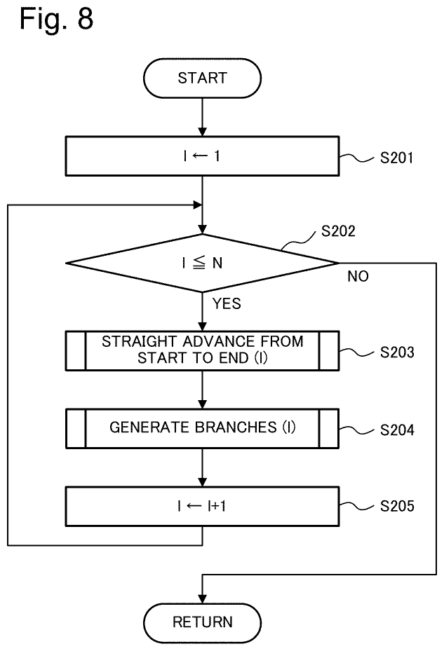

FIG. 8 is a flowchart illustrating the processing of construction of the node table in the calculation system according to the example embodiment of the present invention. The following describes the processing of the construction S2 of the node table.

The node table construction unit 102 generates a node table by two-step processing of straight advance from a start to an end (step S203) and generation of branches (step S204).

The node table construction unit 102 repeats step S203 and step S204 for a period in which a loop variable “l” is 1 to N (step S201, Yes at step S202, step S205, and l=1, 2, . . . N). When loop processing of step S203 and step S204 is ended (No at step S202), the node table construction unit 102 ends the processing of the construction S2 of the node table.

The above is the processing of the construction S2 of the node table.

From here, more detailed description is made on the processing of the straight advance from the start to the end in l-th stage (step S203), which is the first definition processing.

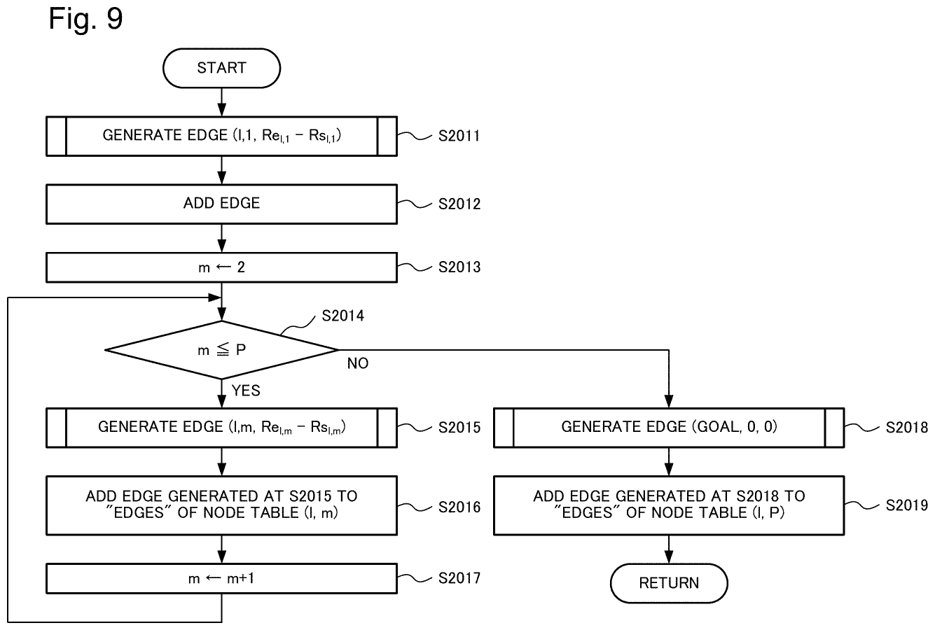

FIG. 9 is a flowchart illustrating the processing of the straight advance from the start to the end in the calculation system according to the example embodiment of the present invention. The processing of the straight advance from the start to the end (step S203) is processing of defining a relation between the resources in one stage. In other words, the processing is processing of defining a time zone available after use of a certain management resource.

The node table construction unit 102 substitutes a value of “l” for an element in a column of “toNode_i” at an edge, substitutes 1 for an element in a column of “toNode_j” at the edge, and substitutes a value of (d=“start time Rs_{1,1}”−“end time Re_{1,1}”) for an element in a column of “edgeCost” at the edge (step S2011).

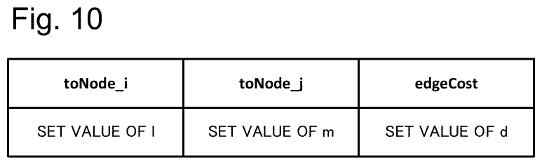

FIG. 10 is a diagram illustrating a data structure of an edge according to the example embodiment of the present invention. The edge is data having a structure of a one-dimensional array that includes column items of “toNode_i”, “toNode_j”, and “edgeCost”.

Next, the node table construction unit 102 adds the edge generated at step S2011 to “EDGES” in a row associated with the node table (i=START, j=0) (step S2012).

The node table construction unit 102 repeats the following step S2015 and step S2016 for a period in which a loop variable “m” is 2 to P (step S2013, Yes at step S2014, step S2017, and m=2, 3, . . . P).

The node table construction unit 102 substitutes a value of “l” for the element in the column of “toNode_i” at the edge, substitutes a value of “m” for the element in the column of “toNode_j” at the edge, and substitutes a value of (d=“start time Rs_{1,m}”−“end time Re_{1,m}”) for the element in the column of “edgeCost” at the edge (step S2015).

Next, the node table construction unit 102 adds the edge generated at step S2015 to “EDGES” of the node table (i=l, j=m) (step S2016). After step S2016, the processing proceeds to step S2017.

When the loop processing of step S2015 and step S2016 is ended (No at step S2014), next, the node table construction unit 102 substitutes “GOAL” for the element in the column of “toNode_i” at the edge, and substitutes 0 for the element in the column of “toNode_j”, and substitutes 0 for the element in the column of “edgeCost” at the edge (step S2018).

Next, the node table construction unit 102 adds the edge generated at step S2018 to “EDGES” of the node table (i=l, j=P) (step S2019). When step S2019 is ended, the node table construction unit 102 ends the processing of the straight advance from the start to the end (step S203).

The above is the details of the processing of the straight advance (step S203) from the start to the end in the l-th stage.

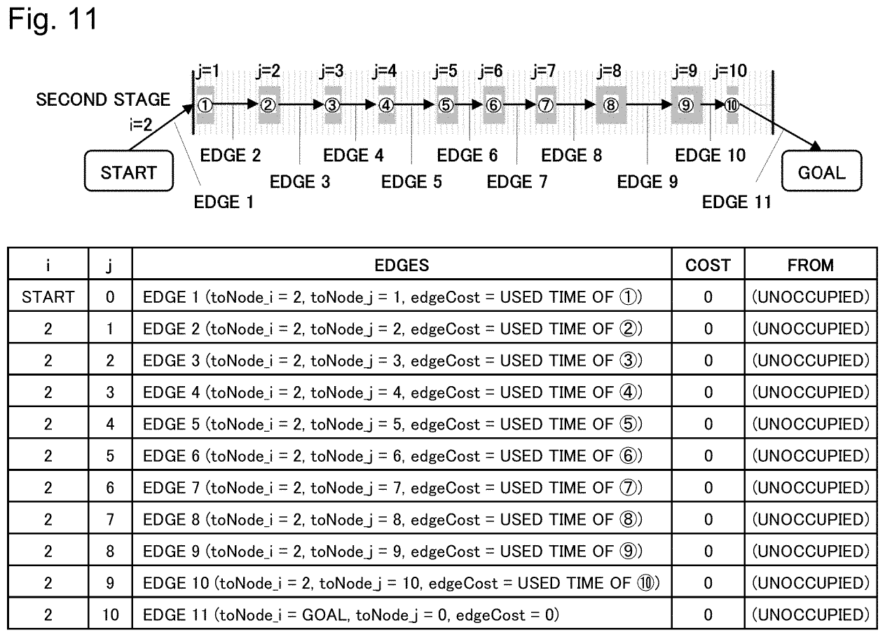

FIG. 11 is a diagram illustrating one example of the node table after the processing of the straight advance from the start to the end in second stage is performed, according to the example embodiment of the present invention. The processing of the straight advance from the start to the end (step S203) generates the edges in such a way as to make connections one by one from “START” to “GOAL” with “START” being a top in the stage, and with “GOAL” being an end (an upper part in FIG. 11), and registers the edges in the node table. A resource that is a beginning point of the edge is indicated by “i, j” in the node table. Further, a resource that is an end point of the edge is indicated by “toNode_i, toNode_j” of “EDGES”. A used time of the resource that is an end point of the edge is indicated by “edgeCost” of “EDGES” (a lower part in FIG. 11).

From here, detailed description is made on the processing of generating branches in the l-th stage (step S204), which is the second definition processing.

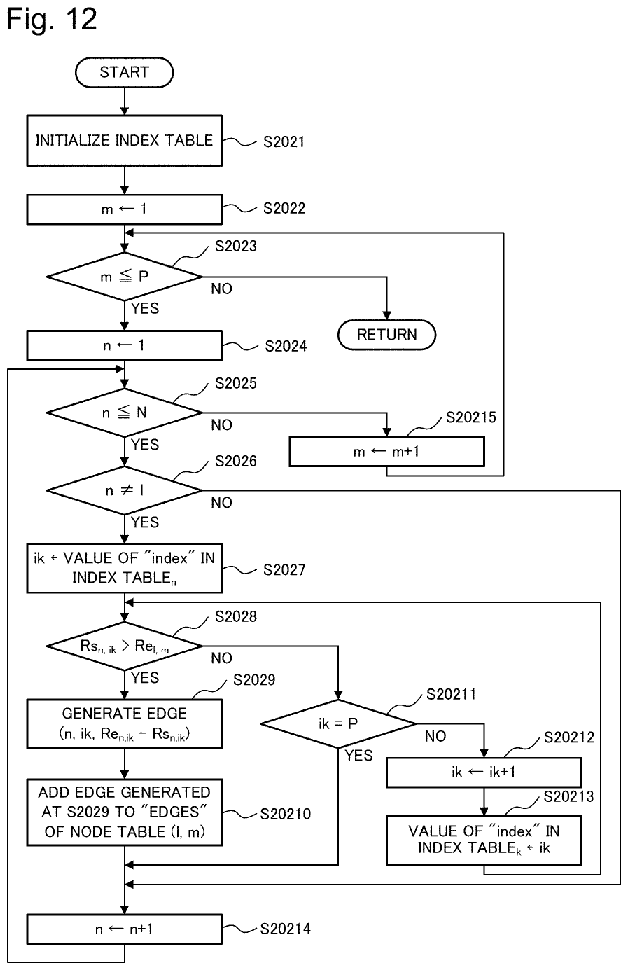

FIG. 12 is a flowchart illustrating the processing of generating branches in the calculation system according to the example embodiment of the present invention. The processing of generating branches (step S204) is processing of defining a relation between a resource from one stage to a resource from another stage. In other words, the processing is processing of defining another management resource available after use of a certain management resource, and defining a time zone thereof.

The node table construction unit 102 substitutes “0” for all elements in a column of “index” in an index table (step S2021).

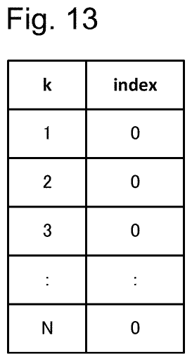

FIG. 13 is a diagram illustrating a data structure of the index table according to the example embodiment of the present invention. The index table is data having a two-dimensional array structure that includes column items of “k” and “index”.

The node table construction unit 102 repeats steps from step S2024 to step S20214 for a period in which the loop variable “m” is 1 to P (a step S2022, Yes at step S2023, step S20215, and m=1, 2, . . . P). When the loop processing from step S2024 to step S20214 is ended (No at step S2023), the node table construction unit 102 ends the processing of generating branches in the l-th stage (step S204).

Further, the node table construction unit 102 repeats steps from step S2027 to step S20213 for a period in which the loop variable “n” is 1 to N (step S2024, Yes at step S2025, step S20214, and n=1, 2, . . . N). However, the processing is not performed in a case of n=1 (step S2026). A reason why the processing is not performed is that the processing of the same stage is performed in the processing of “the straight advance from the start to the end (S201)”. When loop processing from step S2027 to step S20213 is ended (No at step S2025), the processing proceeds to step S20215.

The node table construction unit 102 substitutes a value of “index” in the index table (k=n) for a variable “ik” (step S2027).

Next, the node table construction unit 102 determines whether or not “Rs_{n,ik}>Re_{1,m}” is satisfied (step S2028). Thereby, whether ik-th resource in n-th stage can be used next after m-th resource in the l-th stage is determined.

When “Rs_{n,ik}>Re_{1,m}” is satisfied at step S2028 (Yes in step S2028), next, the node table construction unit 102 substitutes a value of “n” for the element in the column of “toNode_i” at the edge, substitutes a value of “ik” for the element in the column of “toNode_j” at the edge, and substitutes a value “d” of “d=Re_{n,ik}−Rs_{n,ik}” for the element in the column of “edgeCost” at the edge (step S2029). Next, the node table construction unit 102 adds the edge generated at step S2029 to “EDGES” (step S2029) of the node table (i=1, j=m) (step S20210). After step S20210, the processing proceeds to step S20214.

When “Rs_{n,ik}>Re_{1,m}” is not satisfied at step S2028 (No at step S2028), next, the node table construction unit 102 determines whether or not “ik=P” is satisfied (step S20211).

When “ik=P” is satisfied at step S20211 (Yes at step S20211), the processing proceeds to step S20214.

When “ik=P” is not satisfied at step S20211 (No at step S20211), the node table construction unit 102 substitutes “ik+1” for the variable “ik” (step S20212). Next, the node table construction unit 102 substitutes a value of the variable “ik” for “index” of the index table (k=n) (step S20213). After step S20213, the processing proceeds to step S2028.

The above is the details of the processing of generating branches in the l-th stage (step S204). In this processing, another time zone of a management resource before an already-defined time zone of the management resource is not selected as a processing target, thereby improving efficiency of the processing process.

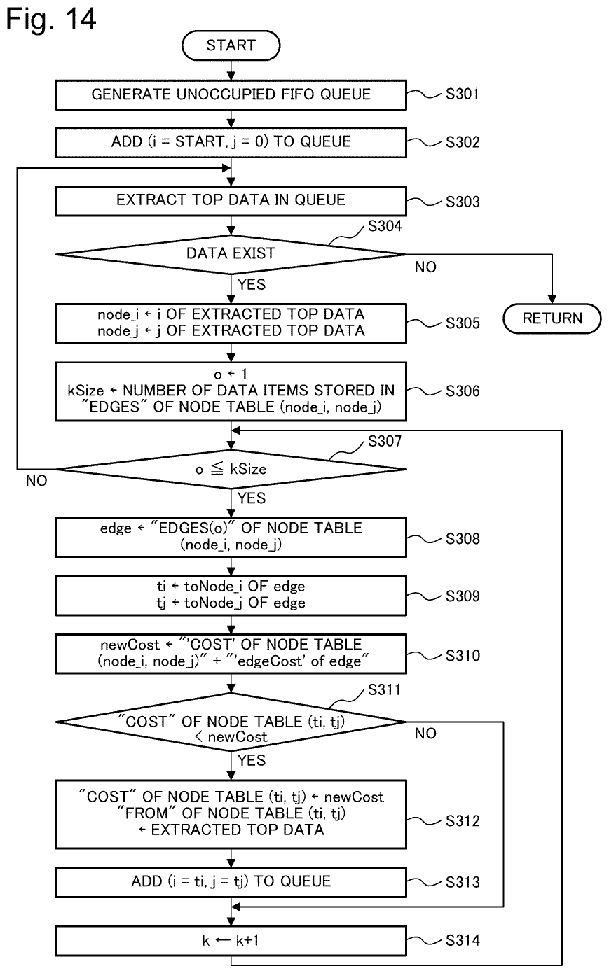

FIG. 14 is a flowchart illustrating the processing of searching for the longest path in the calculation system according to the example embodiment of the present invention. The following describes the processing of the searching S3 for the longest path.

The longest path search unit 103 generates an unoccupied FIFO queue (step S301). Next, the longest path search unit 103 adds (i=START, j=0) to the queue generated in step S301 (step S302).

The longest path search unit 103 repeats steps from following step S305 to step S314 until the queue generated at step S301 becomes unoccupied (step S303, Yes at a step S304). When the queue generated at step S301 is unoccupied (No at step S304), the longest path search unit 103 ends the processing of the searching S3 for the longest path.

The longest path search unit 103 substitutes “i” of top data extracted at step S303 for a variable “node_i”, and substitutes “j” of the top data extracted at step S303 for a variable “node_j” (step S305). Next, the longest path search unit 103 substitutes “l” for a variable “o”, and substitutes, for a variable “ksize”, the number of data items stored in “EDGES” of the node table (i=node_i, j=node_j) (step S306).

The longest path search unit 103 repeats steps from following step S308 to a step S313 for a period in which “o≤kSize” is satisfied (Yes at step S307, step S314). When “o≤kSize” is not satisfied (No at step S307), the processing proceeds to step S303.

The longest path search unit 103 substitutes, for a variable “edge”, o-th data stored in “EDGES” of the node table (i=node_i, j=node_j) (step S308).

Next, the longest path search unit 103 substitutes “toNode_i” of the variable “edge” for a variable “ti”, and substitutes “toNode_j” of the variable “edge” for a variable “tj” (step S309).

Next, the longest path search unit 103 substitutes, for a variable “newCost”, the sum of “COST” of the node table (i=node_i, j=node_j) and “edgeCost” of the variable “edge” (step S310).

Next, the longest path search unit 103 determines whether or not “‘COST’ of node table (i=ti, j=tj)<‘newCost’” is satisfied (step S311).

When “‘COST’ of node table (i=ti, j=tj)}<‘newCost’” is satisfied at step S311 (Yes at step S311), next, the node table construction unit 102 substitutes the variable “newCost” for “COST” of the node table (i=ti, j=tj), and substitutes, for “FROM” of the node table (i=ti, j=tj), the top data extracted at step S303 (step S312).

Next, the longest path search unit 103 adds (i=ti, j=tj) to the queue (step S313). After step S313, the processing proceeds to step S314.

When “‘COST’ of node table (i=ti, j=tj)<‘newCost’” is not satisfied at step S311 (No at step S311), the processing proceeds to step S314.

The above is the processing of the searching S3 of the longest path.

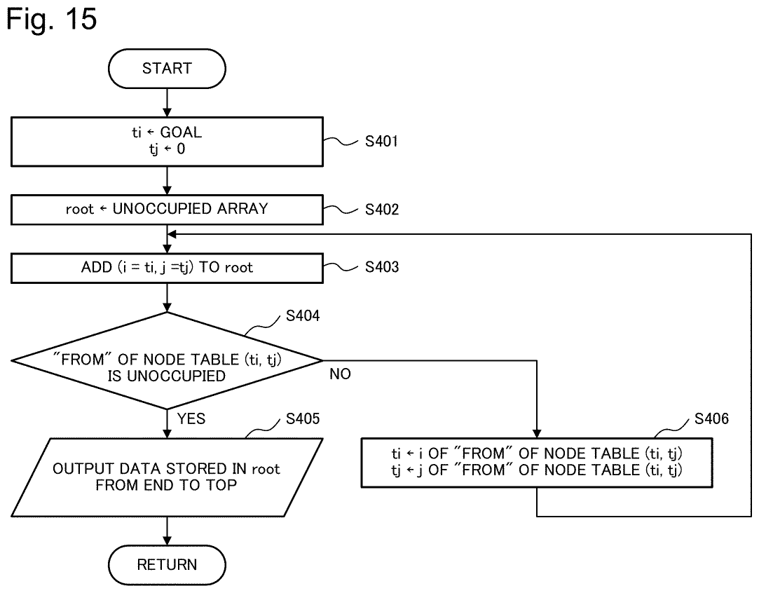

FIG. 15 is a flowchart illustrating the processing of outputting a solution in the calculation system according to the example embodiment of the present invention. The following describes the processing of the outputting S4 of a solution.

The solution output unit 104 substitutes “GOAL” for a variable “ti”, and substitutes 0 for a variable “tj” (step S401). Next, the solution output unit 104 generates an unoccupied array “root” (step S402), and adds (i=ti, j=tj) to the array “root” (step S403).

Next, the solution output unit 104 determines whether or not “FROM” of the node table (i=ti, j=tj) is unoccupied (step S404).

When “FROM” of the node table (i=ti, j=tj) is unoccupied at step S404 (Yes at step S404), next, the solution output unit 104 outputs the data stored in “root”, from the end to the top (step S405). When step S405 is ended, the solution output unit 104 ends the processing of outputting S4 of a solution.

When “FROM” of the node table (i=ti, j=tj) is not unoccupied at step S404 (No at step S404), next, the solution output unit 104 substitutes “i” of “FROM” of the node table (i=ti, j=tj) for the variable “ti”, and substitutes “j” of “FROM” of the node table (i=ti, j=tj) for the variable “tj” (step S406). After step S406, the processing proceeds to step S403.

The above is the processing of the outputting S4 of a solution.

### (Advantageous Effect)

According to the present example embodiment, only the time zone of the management resource after the most posterior time zone among the already-defined time zones of the management resources is selected as a processing target, and another time zone of the management resource before the already-defined time zone of the management resource is not selected as a processing target, thereby improving efficiency of the processing process. Further, according to the present example embodiment, a processing speed is dramatically improved by converting “a resource allocation problem” into “a longest path problem”.

### (Hardware Configuration)

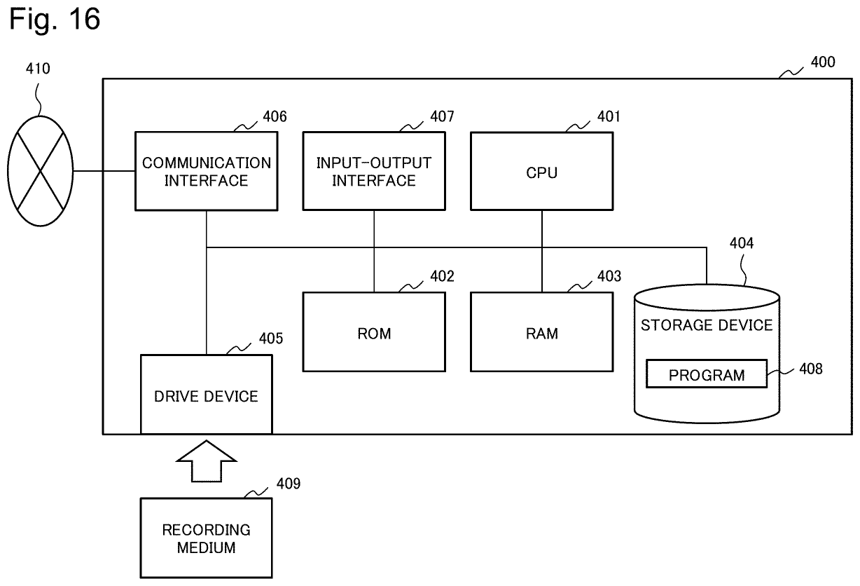

FIG. 16 is a block diagram illustrating one example of a hardware configuration of a computer device according to the example embodiment of the present invention. The computer device 400 is one example of a device that implements the above-described calculation system 100. The computer device 400 includes a central processing unit (CPU) 401, a read only memory (ROM) 402, a random access memory (RAM) 403, a storage device 404, a drive device 405, a communication interface 406, and an input-output interface 407. The calculation system 100 can be implemented by a configuration (or a part thereof) illustrated in FIG. 16.

The CPU 401 executes a program 408, using the RAM 403. The program 408 may be stored in the ROM 402. Alternatively, the program 408 may be recorded in a recording medium 409 such as a flash memory and be read out by the drive device 405, or may be transmitted from an external device via a network 410. The communication interface 406 exchanges data with an external device via the network 410. The input-output interface 407 exchanges data with a peripheral device (such as an input device and a display device). The communication interface 406 and the input-output interface 407 can function as a means for acquiring or outputting data.

Note that each of the node table initializing unit 101, the node table construction unit 102, the longest path search unit 103, the solution output unit 104, and the like may be configured by a single piece of circuitry (a processor or the like), or may be configured by a combination of a plurality of pieces of circuitry. The circuitry mentioned here may be either a special-purpose circuitry or a general-purpose circuitry. Alternatively, the node table initializing unit 101, the node table construction unit 102, the longest path search unit 103, the solution output unit 104, and the like may be configured by a single piece of circuitry.

The present invention is not limited to the above-described example embodiment, and various modifications can be made within the scope of the invention described in claims, and needless to say, are also included in the scope of the present invention. In other words, various aspects that can be understood by those skilled in the art can be applied to the present invention within the scope of the present invention.

This application is based upon and claims the benefit of priority from Japanese patent application No. 2017-069455, filed on Mar. 31, 2017, the disclosure of which is incorporated herein in its entirety by reference.

### REFERENCE SIGNS LIST

100 Calculation system
101 Node table initializing unit
102 Node table construction unit
103 Longest path search unit
104 Solution output unit
400 Computer device
401 Central processing unit (CPU)
402 Read only memory (ROM)
403 Random access memory (RAM)
404 Storage device
405 Drive device
406 Communication interface
407 Input-output interface
408 Program
409 Recording medium
410 Network

1. A calculation system, when a plurality of management resources that can be used a plurality of times within a period from a start time to an end time are used without overlapping in time for a time as long as possible, comprising:
a memory that stores a set of instructions; and
at least one processor configured to execute the set of instructions to:
concerning each of all management resources, perform first definition processing of defining a next time zone being available after use of the management resource, and perform second definition processing of defining another management resource and a time zone of the another management resource being available after the use of the management resource;
trace, one by one, the management resources and the time zones of the management resources being defined, and thereby detect a longest process for which a sum of used time is longest; and
output the longest process being detected, wherein,
in the second definition processing, the at least one processor is configured to execute the set of instructions to select, as a processing target, only a time zone of the management resource after a most posterior time zone among already-defined time zones of the management resources.

2. A calculation method, when a plurality of management resources that can be used a plurality of times within a period from a start time to an end time are used without overlapping in time for a time as long as possible, comprising:
performing, concerning each of all management resources, first definition processing of defining a next time zone being available after use of the management resource, and performing second definition processing of defining another management resource and a time zone of the another management resource available after the use of the management resource;
tracing, one by one, the management resources and the time zones of the management resources being defined, and thereby detecting a longest process for which a sum of used time is longest; and
outputting the longest process being detected, wherein,
in the second definition processing, only a time zone of the management resource after a most posterior time zone among already-defined time zones of the management resources is selected as a processing target.

3. A non-transitory computer-readable recording medium on which a calculation program is recorded, the calculation program causes a computer to execute, when a plurality of management resources that can be used a plurality of times within a period from a start time to an end time are used without overlapping in time for a time as long as possible:
concerning each of all management resources, first definition processing of defining a next time zone being available after use of the management resource, and second definition processing of defining another management resource and a time zone of the another management resource being available after the use of the management resource;
processing of tracing, one by one, the management resources and the time zones of the management resources being defined, and thereby detecting a longest process for which a sum of used time is longest; and
processing of outputting the longest process being detected, wherein,
in the second definition processing, only a time zone of the management resource after a most posterior time zone among already-defined time zones of the management resources is selected as a processing target.
